(19) United States
(12) Patent Application Publication
(10) Pub. No.: US 2008/0303269 A1
(43) Pub. Date: Dec. 11, 2008

(54) FERROUS PIPE COUPLINGS AND PRELUBRICATED COUPLING GASKETS

(75) Inventor: JOSEPH G. RADZIK, Easton, PA (US)

Correspondence Address: FOR: TYCO FIRE & BUILDING PRODUCTS;PROSKAUER ROSE LLP, 1001 Pennsylvania Avenue, NW, Suite 400 South, Washington, DC, 20004-2533, US

(73) Assignee: CENTRAL SPRINKLER CORPORATION, Lansdale, PA (US)

(21) Appl. No.: 12/189,700

(22) Filed: Aug. 11, 2008

Related U.S. Application Data
(63) Continuation of application No. 09/965,983, filed on Sep. 28, 2001, now abandoned.

(51) Int. Cl. F16L 7/00

(52) U.S. Cl. 285/94

(57) ABSTRACT

One-piece, elastomeric gaskets for ferrous pipe couplings and the like are prelubricated with a coating of dry powder lubricant before installation. This coating can be applied before installation and as early as assembly by the manufacturer. The gaskets are combined with split ring collars to form couplings for pneumatic and hydraulic piping systems, including fire sprinkler systems, among others. The lubricant can be an organic starch powder derived from corn, rice, potatoes or other crops, talc or its primary ingredient, magnesium silicate hydroxide, or a combination of organic or organic and inorganic lubricant powders.

### PRIORITY DATA & INCORPORATION BY REFERENCE

This application is a Continuation Application of Ser. No. 09/965,983, filed Sep. 28, 2001, which is incorporated by reference in its entirety.

### BACKGROUND OF THE INVENTION

Elastomeric pipe coupling gaskets that are commonly used with ferrous pipe couplings are lubricated so that they are not damaged during installation. Various types of oils and/or greases are used depending upon the gasket, pipe, fitting and coupling materials involved. However, such lubrication is usually supplied in a separate container and then manually applied to the gasket just prior to installation. This keeps the lubricant fresh and prevents the collection of dirt and debris on the lubricant coating prior to use of the gasket. However, it makes for a time-consuming and messy installation process.

### BRIEF SUMMARY OF THE INVENTION

In one aspect, the invention is a lubricated ferrous pipe coupling gasket comprising a generally tubular, one-piece, elastomeric member with first and second axial open ends, the member being formed by a circumferential wall and at least a pair of circumferential flanges, each flange extending at least generally radially inwardly at a separate one of the first and second axial open ends of the member, the circumferential wall and the pair of circumferential flanges forming at least one circumferential channel on an inner circumferential side of the member; and a coating of dry powder lubricant on at least the inner circumferential side of the member.

In another aspect, the invention is a ferrous pipe coupling comprising a ferrous collar having an outer, axially extending, axially split circumferential wall with at least one pair of adjoining circumferential ends at the split; at least one fastener releasably securing together the at least one pair of adjoining, circumferential ends of the collar; a gasket in the form of a generally tubular, one-piece, elastomeric member positioned in the collar and having an inner circumferential side exposed in the collar; and a coating of dry powder lubricant on at least the exposed, inner circumferential side of the elastomeric member.

In yet another aspect, the invention is a ferrous piping system comprising a plurality of ferrous piping components; and at least one ferrous pipe coupling mechanically and fluidly joining together ends of a pair of the piping components at a joint. The ferrous pipe coupling includes a ferrous collar having an outer, axially extending and axially split, circumferential wall and at least one pair of adjoining circumferential ends at the split, a gasket in the form of a generally tubular, one-piece elastomeric member having an inner circumferential side sealingly mounted on the ends of the pair of piping elements and surrounded by the collar; a coating of dry powder lubricant at least between the inner circumferential side of the gasket and the ends of the pair of piping components, and at least one fastener releasably securing together the pair of adjoining, circumferential ends of the collar together so as to compress the collar on the gasket and the gasket on the ends of the pair of piping components.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a diagrammatic sketch of a portion of a ferrous piping system utilizing the present invention and configured to supply water for fire sprinkler protection;

FIG. 2 is a detailed exploded view of one of the joints at one of the ends of the Tee fitting of FIG. 1;

FIG. 3 is a localized cross-section through a flexible joint formed by a split ring ferrous coupling with prelubricated elastomeric gasket;

FIG. 4 is a localized cross-section through a rigid joint formed by a split ring ferrous coupling with prelubricated elastomeric gasket;

FIG. 5 is a localized cross-section through a rigid joint formed by a split ring ferrous coupling and a second type of prelubricated elastomeric gasket; and

FIG. 6 depicts a hinged type of split ring, ferrous pipe coupling; and

FIG. 7 depicts a second type of hinged, split ring, ferrous pipe coupling.

### DESCRIPTION OF THE INVENTION

Like reference numerals are used to identify the same elements to various drawings.

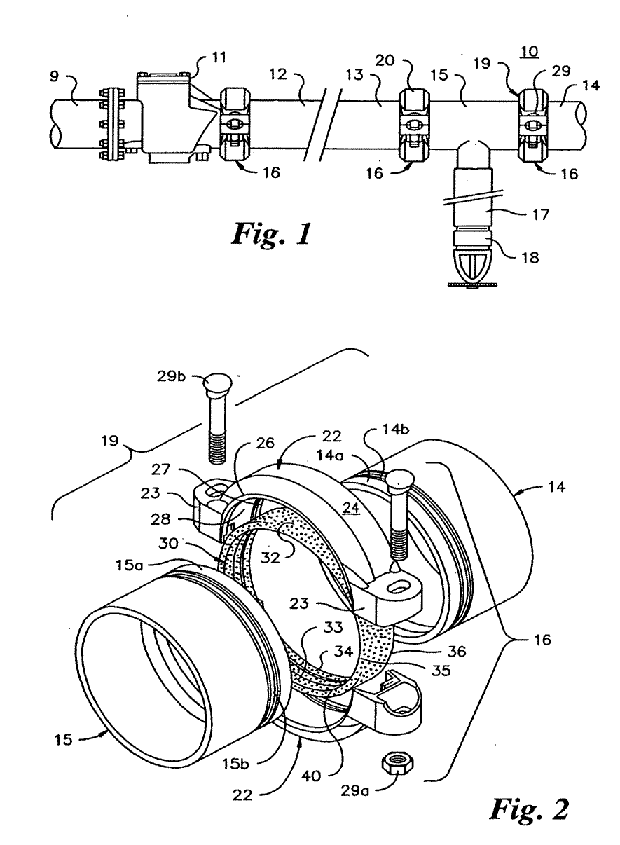

FIG. 1 depicts diagrammatically a portion of a ferrous piping system indicated generally at 10.

The system includes a plurality of piping components 11-17, which, for the most part, are lengths of pipe, couplings and fittings which have fluid passages therethrough. System 10 is configured in particular for water distribution as part of a fire sprinkler system. A one-way valve 11 is coupled with a potable water supply represented by a potable water supply pipe 9 and is arranged to supply water in only one direction from the supply pipe 9 to the piping system 10. The piping system 10 utilizing the present invention is a ferrous system utilizing lengths of iron or steel pipe and appropriate iron or steel fittings, couplings and other components for use with those pipes.

The portion of the piping system 10 depicted includes different piping components typically found in a fire sprinkler system. Elements 12 through 14 are lengths of straight pipe. Element 15 is a Tee fitting. Elements 16 are preferably identical, ferrous, split ring pipe couplings. Element 17 is a drop, a length of pipe of reduced diameter in comparison to pipe lengths 12 through 14. Finally, element 18 is an automatic fire sprinkler of conventional construction. The term “piping components” includes pipe lengths, valves, fittings and like fluid passage elements having one or more open tubular ends, which can be joined together by appropriate couplings or the like, forming joints between adjoining components, as well as plugs used in such systems.

FIG. 2 is an exploded view of the joint 19 made between a first piping component, pipe length 14, and a second piping component, Tee fitting 15, by one of the ferrous pipe couplings 16. Ferrous pipe coupling 16 includes a split ring ferrous collar (indicated generally at 20 in FIG. 1) preferably formed by a plurality of identical ring segments 22, which are releasably secured together end to end at pairs of adjoining circumferential ends by suitable and conventional means, in this case each fastener 29 (FIG. 1) formed by nut 29a and bolt 29b combination in which the bolt 29b passed through a bolt pad 23 at each circumferential end of each ring segment 22. The two separate segments define two axial splits in the collar. At least one split is required to mount the collar. The ferrous pipe coupling 16 further includes a gasket 30 in the form of a generally tubular, one-piece, elastomeric member.

The coupling 16 depicted in FIG. 2 mechanically and fluidly joins together ends 14a and 15a, respectively, of pipe length 14 and Tee fitting 15 at joint 19. Preferably, components 11-16 are grooved piping components made of ductile iron. That is, at least one and generally at least two tubular ends of each valve 11, length of pipe 12-14 and fitting 15 is provided with a circumferential groove, which is interferingly engaged by the collar 20 of the coupling 16 to retain the components 14 and 15 together. These grooves are indicated at 14b and 15b, respectively, in FIG. 2.

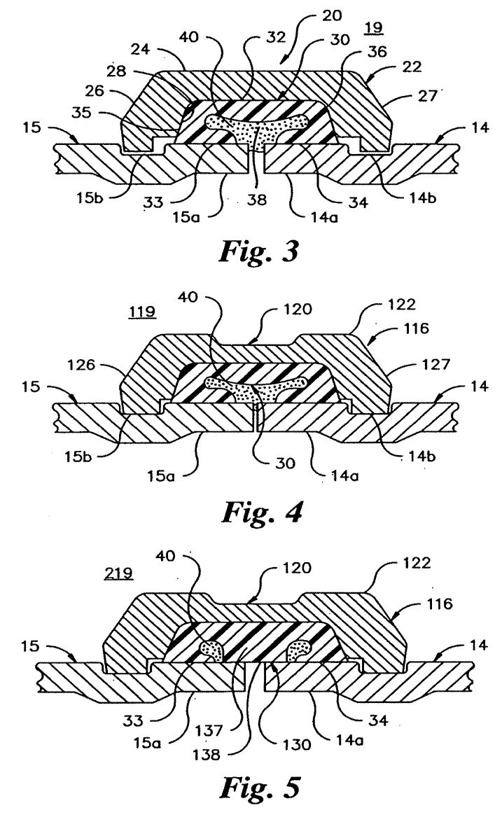

Depending upon the nature of the coupling 16, the joint 19 can be rigid or flexible. A typical flexible joint is depicted in cross-section in FIG. 3 showing a portion of one of the ring segments 22 as well as a portion of the gasket 30. Each split ring ferrous collar 20 has an outer, axially extending, split circumferential wall 24 and a pair of axially flanking, generally radially inwardly and preferably axially outwardly extending circumferential flanges 26 and 27. Each flange 26 and 27 is located generally at a separate axial end of the circumferential wall 24. The pair of circumferential flanges 26 and 27 and the circumferential wall 24 form a generally circumferential channel 28 on an inner circumferential side of the collar 20. Gasket 30 is positioned in the channel 28. The ring segments 22 of the collar 20 are sized in such a way that when the ends (e.g., the bolt pads 23) are brought together with the fasteners 29, they contact and bottom against one another before the circumferential flanges 26, 27 of the collar 20 bottom against the innermost circumferential surface of the groove 14b, 15b. The flexible coupling 16 allows for some annular deflection between the piping components, which permit some minor bending between the joined piping components. They further permit some axial movement for thermal expansion and contraction.

Gasket 30 is preferably a generally tubular, one-piece, elastomeric member including a circumferential wall 32 and a pair of circumferential flanges 33 and 34 located generally at first and second open axial ends 35, 36, respectively, of the circumferential wall 32 and of the gasket 30. Flanges 33 and 34 each extend at least generally radially inwardly. The circumferential wall 32 and the pair of flanges 33 and 34 also form a circumferential channel 38 on an inner circumferential side of the gasket 30. The gasket 30 may be formed from any of a variety of suitable elastomeric, preferably polymeric materials. Suggestedly, the polymer is a nitrile or an ethylene, propylene, diene monomer (“EPDM”). One-piece gasket 30 can be molded in a seamless, one-piece, continuous ring or extruded and spliced by bonding into a seamed, one-piece, continuous ring, for example, with the use of a suitable adhesive or solvent.

In use, the gasket 30 is stretched over the end 14a or 15a of one of the piping components 14, 15 and then over the other end as the ends 14a, 15a of the two components are brought together. The split ring ferrous collar 20 is then extended over and around the gasket 30 and the ends 14a, 15a of the components 14, 15 being joined. The stretched gasket 30 forms seals with both ends 14a, 15a. In order to prevent subsequent leakage, it is important that the circumferential inner side (i.e., the inner faces of the flange portions 33, 34) of the gasket 30 not be scraped or cut when being mounted on the ends 14a, 15a of the piping components. Otherwise, the gasket 30 may leak through the damaged area. For that reason, such gaskets are typically coated with an oily liquid or greasy solid material so as to be more easily and safely slipped over the adjoining ends of the piping components. However, according to the present invention, instead of using a wet liquid or greasy solid, the gasket 30 or at least the inner circumferential side of the gasket 30, which is exposed to and which directly contacts the ends 14a, 15a of the joined piping components 14, 15, is covered with a coating of dry cornstarch powder. The surface coating of cornstarch powder is indicated by shading at 40 in FIG. 2 and in the subsequent FIGS. 4 through 6. Preferably, the cornstarch is simply a conventional commercial grade powder. It can be applied to the gasket 30 simply by tumbling the gasket 30 with cornstarch powder in a suitable agitator. A drum, rotating at a speed suitable to tumble the gasket and to tumble the powder on(to) the gasket may be used. For example, a three foot diameter drum positioned essentially on its side may be rotated between about 20 and 40 rpm for a few minutes to cover a gasket inside and out with an amount of cornstarch effective to lubricate its mounting over piping component ends. The dry cornstarch powder tends to uniformly cover all surfaces of the dry elastomeric member 30, possibly by electrostatic attraction, at least for the nitrile and EPDM elastomeric identified above. The cornstarch powder can be applied at any time before installation but is preferably applied during manufacture before assembly of the coupling. The coupling can then be shipped to distributors and end users in a prelubricated form ready for installation. It has been found that the cornstarch powder cannot be significantly removed by simple rubbing or handling. It is not sticky or tacky and does not attract dust, dirt or other contaminants before use.

FIG. 4 depicts the joint 119 formed by a rigid coupling 116 with a collar 120 in which the adjoining ends of the ring segments 122 can be compressed together sufficiently by the fastener(s) 29 (See FIGS. 1-2) for the inner circumferential surface of each circumferential flange portion 126, 127 of the collar 120 to bottom against the innermost surface of the circumferential groove 14b, 15b on the joined piping components 14, 15. Rigid couplings are used where pipe movement is undesirable such as in relatively long runs of pipe to minimize the requirements for external supports and in risers.

FIG. 5 shows a similar joint 219 formed with rigid coupling 116 which utilizes a different type of gasket 130 having a central flange 137 with sealing surface 138 which spans both ends 14a, 15a.

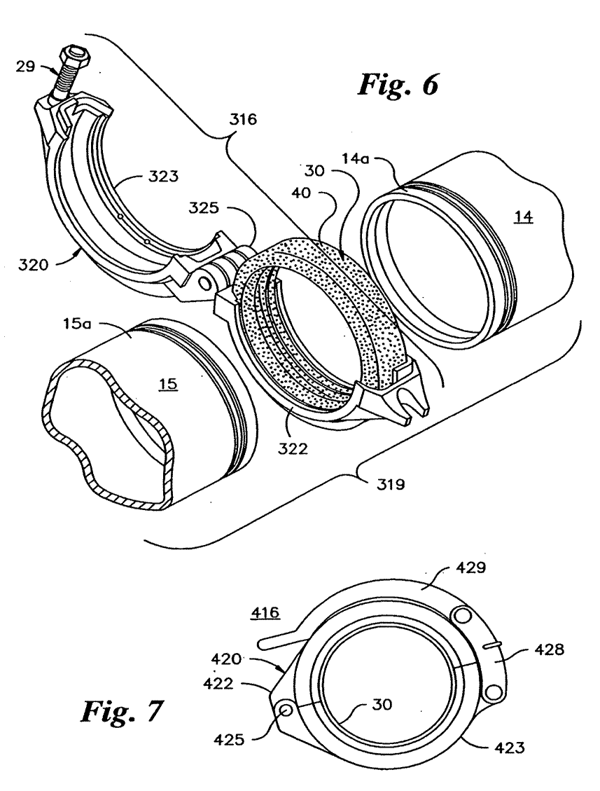

FIG. 6 depicts a joint 319 between ends of piping components 14, 15, which is formed by a first type of gasketed hinged coupling indicated generally at 316. Coupling 316 includes a collar 320 formed by a pair of split ring segments 322, 323, which are coupled together at one of their pair of adjoining ends by a hinge 325. Again, a releasable fastener 29 is used to releasably secure together the remaining adjoining ends of the segments 322, 323, around a powdered cornstarch coated gasket 30 and ends 14a, 15a of piping components 14 and 15.

FIG. 7 depicts a second type of gasketed hinged coupling indicated generally at 416. Coupling 416 includes a collar 420 formed by segments 422, 423 hinged together at one end 425 in which the remaining pair of adjoining ends are brought together and releasably secured by a fastener in the form of a hinged latch member 428 and an over center hinged locking pivot lever 429, which is itself hinged to the latch member 428. An inner channel receives a gasket 30 with powdered cornstarch coating.

While dry, powdered cornstarch is preferred, other dry, powdered organic starches such as rice starch and potato starch might alternatively be used. In addition, a powder predominantly or essentially composed of talc, i.e. magnesium silicate hydroxide (Mg₃Si₄O₁₀(OH)₂), which is the primary ingredient of conventional talcum powder, or that powder itself might be used as a dry lubricant. Corn, rice and potato starches, being natural ingredients derived from crops, can, with other similar naturally derived starches, be referred to generically as organic starch powder. The lubricant can include as a primary component, one of the aforementioned individual materials in combination with lesser amount(s) of the other(s).

While at least two forms of split ring, ferrous collar couplings have been disclosed, those of ordinary skill in the art will appreciate powdered cornstarch can be used on other ferrous collar coupling gaskets for use on grooved ferrous piping components as well as on other iron and steel piping components. While the split ring, ferrous collars 20, 120 and 220 and 320 described each have two ring segments, it will be appreciated that three or more segments can be employed and may be necessary in larger sizes. The segments may be identical or simply matingly symmetric for simple assembly and mounting. Similarly, in some cases, a one-piece collar of spring steel or other metal having only one pair of adjoining ends held together with a threaded fastener or a latching member might be used with a prelubricated gasket. It further will be appreciated that the present invention can be used with tubular gaskets of other configurations such as gaskets without an inner circumferential channel or distinct flanges. It will further be appreciated that while the intended use of a cornstarch lubricated polymer gasket is in fire protection systems, including automatic and deluge sprinkler piping systems, such lubricated gaskets can be installed in piping systems for other uses. Suggestedly, they are used in piping systems that are isolated from potable water supplies by suitable means such as one-way valves or in water supply systems not coupled with potable water supplies. These include various irrigation, cooling, heating and drainage systems, as well as certain other agricultural or commercial hydraulic and/or pneumatic systems.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1. A lubricated ferrous pipe coupling gasket comprising:
a generally tubular, one-piece, elastomeric member with first and second axial open ends, the member being formed by a circumferential wall and at least a pair of circumferential flanges, each flange extending at least generally radially inwardly at a separate one of the first and second axial open ends of the member, the circumferential wall and the pair of circumferential flanges forming at least one circumferential channel on an inner circumferential side of the member; and
a powder coating that provides a dry lubricant on at least the inner circumferential side of the pair flanges of the member.

2. The gasket of claim 1 wherein the dry lubricant comprises an organic starch powder.

3. The gasket of claim 1 wherein the dry lubricant consists essentially of organic starch powder.

4. The gasket of claim 1 wherein the dry lubricant is selected from the group consisting of cornstarch, rice starch, potato starch, talc and magnesium silicate hydroxide.

5. A ferrous pipe coupling comprising:
a ferrous collar having an outer, axially extending, axially split circumferential wall with at least one pair of adjoining circumferential ends at the split;
at least one fastener releasably securing together the at least one pair of adjoining, circumferential ends of the collar;
a gasket in the form of a generally tubular, one-piece elastomeric member positioned in the collar and having an exposed inner circumferential side exposed in the collar, the inner circumferential side having at least one flange that forms a seal with a pipe; and
a powder coating that provides a dry lubricant on at least the exposed, inner circumferential side of the elastomeric member.

6. The ferrous pipe coupling of claim 5 wherein the ferrous collar includes a pair of at least generally radially inwardly extending circumferential flanges, each flange being located at a separate axial end of the circumferential wall, the pair of flanges and the circumferential wall forming a circumferential channel on an inner circumferential side of the collar and wherein the gasket is positioned in the channel.

7. The coupling of claim 5 wherein the dry lubricant comprises an organic starch powder.

8. The coupling of claim 5 wherein the dry lubricant consists essentially of organic starch powder.

9. The coupling of claim 5 wherein the dry lubricant is selected from the group consisting of cornstarch, rice starch, potato starch, talc and magnesium silicate hydroxide.

10. A ferrous piping system comprising:
a plurality of ferrous piping components; and
at least one ferrous pipe coupling mechanically and fluidly joining together ends of a pair of the piping components at a joint, the ferrous pipe coupling including:
a ferrous collar having an outer, axially extending and axially split, circumferential wall and at least one pair of adjoining circumferential ends at the split;
a gasket in the form of a generally tubular, one-piece elastomeric member having an inner circumferential side, the inner circumferential side including at least sealingly mounted on the ends of the pair of piping components and surrounded by the collar;
a powder coating that provides a dry lubricant at least between the at least one flange of the inner circumferential side of the gasket and the ends of the pair of piping components; and
at least one fastener releasably securing together a pair of adjoining, circumferential ends of the collar so as to compress the gasket and the collar on the ends of the pair of piping components.

11. The ferrous piping system of claim 10 further comprising:
a one-way valve coupled with the plurality of piping components a potable water supply, the valve being arranged to supply water from the potable water supply to the plurality piping components.

12. The ferrous piping system of claim 11, wherein one of the plurality of piping components is a fitting and further comprising a fire sprinkler coupled with the fitting to be supplied with water by the potable water source through the piping system.

13. The ferrous piping system of claim 11 wherein the dry lubricant comprises an organic starch powder.

14. The ferrous piping system of claim 11 wherein the dry lubricant consists essentially of organic starch powder.

15. The ferrous piping system of claim 11 wherein the dry lubricant is selected from the group consisting of one of cornstarch, rice starch, potato starch, talc and magnesium silicate hydroxide.

16. In a ferrous pipe coupling including a generally tubular, one-piece, elastomeric gasket having at least one flange, a ferrous collar surrounding the gasket, the collar including at least one axial split defining a pair of adjoining circumferential ends, and a fastener releasably securing together the adjoining circumferential ends of the collar, the improvement including a powder coating that provides a dry lubricant on at least an inner circumferential side of the at least one flange of the gasket that forms a seal with a ferrous pipe.

17. The improvement of claim 16 wherein the dry lubricant comprises an organic starch powder.

18. The improvement of claim 16 wherein the dry lubricant consists essentially of organic starch powder.

19. The improvement of claim 16 wherein the dry lubricant is selected from the group consisting of cornstarch, rice starch, potato starch, talc and magnesium silicate hydroxide.

20. The improvement of claim 16 wherein the dry lubricant coats all circumferential surfaces of the gasket.

21. The ferrous pipe coupling of claim 5, wherein the gasket comprises a pair of circumferential flanges formed on the exposed inner circumferential side of the gasket.

22. The ferrous pipe system of claim 10, wherein the gasket comprises a pair of circumferential flanges formed on the inner circumferential side of the gasket.

23. The improvement of claim 20, wherein the dry lubricant coats a pair of flanges formed on the circumferential surface of the gasket.

24. A lubricated ferrous pipe coupling gasket comprising:
a generally tubular, one-piece, elastomeric member with first and second axial open ends, the member being formed by a circumferential wall and at least a pair of circumferential flanges, each flange extending at least generally radially inwardly at a separate one of the first and second axial open ends of the member, the circumferential wall and the pair of circumferential flanges forming at least one circumferential channel on an inner circumferential side of the member; and
a powder coating that provides a dry lubricant electrostatically disposed on at least the inner circumferential side of the pair flanges of the member.

25. A lubricated ferrous pipe coupling gasket comprising:
a generally tubular, one-piece, elastomeric member with first and second axial open ends, the member being formed by a circumferential wall and at least a pair of circumferential flanges, each flange extending at least generally radially inwardly at a separate one of the first and second axial open ends of the member, the circumferential wall and the pair of circumferential flanges forming at least one circumferential channel on an inner circumferential side of the member; and
a powder coating that provides an effective amount of dry lubricant on at least the inner circumferential side of the pair flanges of the member so that each of the pair of flanges slips over the an end of a piping component without damage to the inner circumferential side of each of the pair of flanges.

26. A lubricated ferrous pipe coupling gasket comprising:
a generally tubular, one-piece, elastomeric member with first and second axial open ends an having an exterior surface, the member being formed by a circumferential wall and at least a pair of circumferential flanges, each flange extending at least generally radially inwardly at a separate one of the first and second axial open ends of the member, the circumferential wall and the pair of circumferential flanges forming at least one circumferential channel on an inner circumferential side of the member; and
a powder coating that provides a dry lubricant on at least the inner circumferential side of the pair flanges of the member uniformly covering an exterior surface of the elastomeric member.
